(19) United States
(12) Patent Application Publication
(10) Pub. No.: US 2016/0292168 A1
(43) Pub. Date: Oct. 6, 2016

(54) FILE RETENTION

(71) Applicant: HEWLETT-PACKARD DEVELOPMENT COMPANY, L.P., Houston, TX (US)

(72) Inventors: Kannan K. Ramesh, Bangalore Karnataka (IN); Kannan Rajkumar, Bangalore Karnataka (IN); Sivashanmugam Jothivelavan, Bangalore Karnataka (IN); Roy Annmary, Bangalore Karnataka (IN); Madhu Jagadish, Bangalore Karnataka (IN); Hamilton De Freitas Coutinho, Colorado Springs, CO (US); Guilherme De Campos Magalhaes, Porto Alegre Rio Grande do Sul (BR); Michael J. Spitzer, Portland, OR (US); Raghavendra Saraswathamma Ramu, Bangalore Karnataka (IN)

(21) Appl. No.: 15/036,110

(22) PCT Filed: Dec. 6, 2013
(86) PCT No.: PCT/US2013/073616

§ 371 Date: May 12, 2016

(51) Int. Cl. G06F 17/30

(52) U.S. Cl. CPC G06F 17/30085; G06F 17/30097

(57) ABSTRACT

A method includes accessing a file in a storage device. The method includes placing the file in a retention state. The method includes storing the file's information into a database. The method includes generating a hash of the file's content. The method includes storing the hash in the database with the file's information.

### BACKGROUND

In a file system, a file may be retained such that the file is stored for a period of time. While under retention, the file system may perform validation scans on the retained file to ensure that the integrity of the data contained in the file has not been compromised.

### BRIEF DESCRIPTION OF THE DRAWINGS

Certain exemplary embodiments are described in the following detailed description and in reference to the drawings, in which:

FIG. 1 is a block diagram of a system for retaining a file, in accordance with examples of the present disclosure;

FIG. 2 is a block diagram illustrating retention and validation of a file in a file system, in accordance with examples of the present disclosure;

FIG. 3 is a process flow diagram of a method for retaining a file, in accordance with examples of the present disclosure;

FIG. 4 is a process flow diagram of a method for performing a validation scan, in accordance with examples of the present disclosure;

FIG. 5 is a block diagram of a tangible, non-transitory, computer-readable medium containing instructions to direct a processor to retain a file, in accordance with examples of the present disclosure; and

FIG. 6 is a block diagram of a tangible, non-transitory, computer-readable medium containing instructions to direct a processor to perform a validation scan, in accordance with examples of the present disclosure.

### DETAILED DESCRIPTION OF SPECIFIC EMBODIMENTS

The present disclosure is generally related to file retention in a file system. When a file in a file system is retained, the file system may perform validation scans to check the integrity of the data contained in the file. In some examples, the file system may check each stored file one-by-one to see if the file is in retention or not. If the file is in retention, then the file system performs a validation scan. Otherwise, the file system can skip the particular file. This process may be time-consuming and cumbersome.

Described herein is a method to reduce the amount of time and resources used for validation scans. When a file undergoes retention, a retention event can be recorded in a journal. The unique identifier and location information of the retained filed can be stored in a database. A hash generator can generate a hash of the retained foe. A hash, as described herein, is a datum used to represent the data content of the retained file. The hash may be a checksum, for example. The hash can be recorded into the database and associated with the unique identifier and the location information of the retained file. The information recorded in the database can be used during a validation scan to determine which files in the file system are under retention, thus eliminating the process of checking the retention state of each file one-by-one. Thus, the file system can query the database to select retained files to scan. The described method is more expedient, and can allow for multiple retained files to be validated in parallel, thus optimizing the amount of time required to perform multiple validation scans.

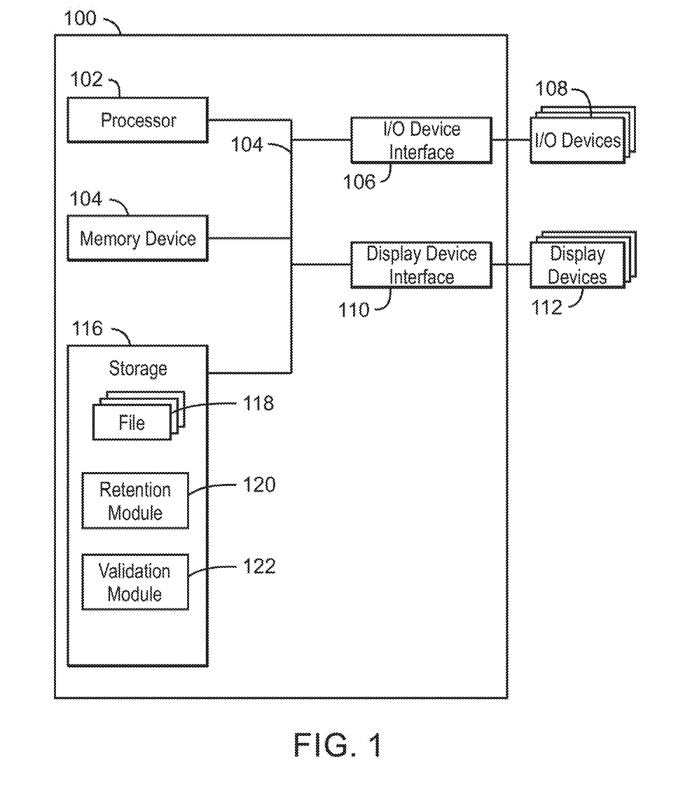

FIG. 1 is a block diagram of a computing system configured for retaining a file, in accordance with examples of the present disclosure. The computing system 100 may include, for example, a server computer, a mobile phone, laptop computer, desktop computer, or tablet computer, among others. The computing system 100 may include a processor 102 that is adapted to execute stored instructions. The processor 102 can be a single core processor, a multi-core processor, a computing cluster, or any number of other appropriate configurations.

The processor 102 may be connected through a system bus 104 (e.g., AMBA®, PCI®, PCI Express®, Hyper Transport®, Serial ATA, among others) to an input/output (I/O) device interface 106 adapted to connect the computing system 100 to one or more I/O devices 108. The I/O devices 108 may include, for example, a keyboard and a pointing device, wherein the pointing device may include a touchpad or a touchscreen, among others. The I/O devices 108 may be built-in components of the computing system 100, or may be devices that are externally connected to the computing system 100.

The processor 102 may also be linked through the system bus 104 to a display device interface 110 adapted to connect the computing system 100 to display devices 112. The display devices 112 may include a display screen that is a built-in component of the computing system 100. The display devices 112 may also include computer monitors, televisions, or projectors, among others that are externally connected to the computing system 100.

The processor 102 may also be linked through the system bus 104 to a memory device 114. In some examples, the memory device 114 can include random access memory (e.g., SRAM, DRAM, eDRAM, EDO RAM, DDR RAM, RRAM®, PRAM, among others), read only memory (e.g., Mask ROM, EPROM, EEPROM, among others), non-volatile memory (PCM, STT_MRAM, ReRAM, Memristor), or any other suitable memory systems.

The processor 102 may also be linked through the system bus 104 to a storage device 116. The storage device 116 may contain one or more files 118 in a file system. The file 118 may be a document, application, media, or any other virtual item that can be stored.

A retention module 120 in the storage device can include instructions to direct the processor 102 to retain a file 118 such that the file 118 can become read-only. The retention module 120 can place the file in a retention state. The retention module 120 can store information pertaining to the retained file 118 in a database. The retention module 120 can generate a hash to represent the contents of the file, and store the hash such that the hash is associated with the information pertaining to the retained file 118.

A validation module 122 in the storage device can include instructions to direct the processor 102 to perform a validation scan on the retained file 118. The validation module 122 can scan the database to quickly determine which of the files 118 in the file system of the storage device 116 has been retained. The validation module 122 can retrieve the stored hash associated with the retained file 118. The validation module 112 can generate a new hash, referred to herein as a validation hash, of the retention file 118 in its current state. The validation module 122 can compare the validation hash to the stored hash to determine whether or not the retained file 118 has undergone any alterations while in the retention state. The validation module 122 can update the database entry of the retained file 118 with results of the comparison.

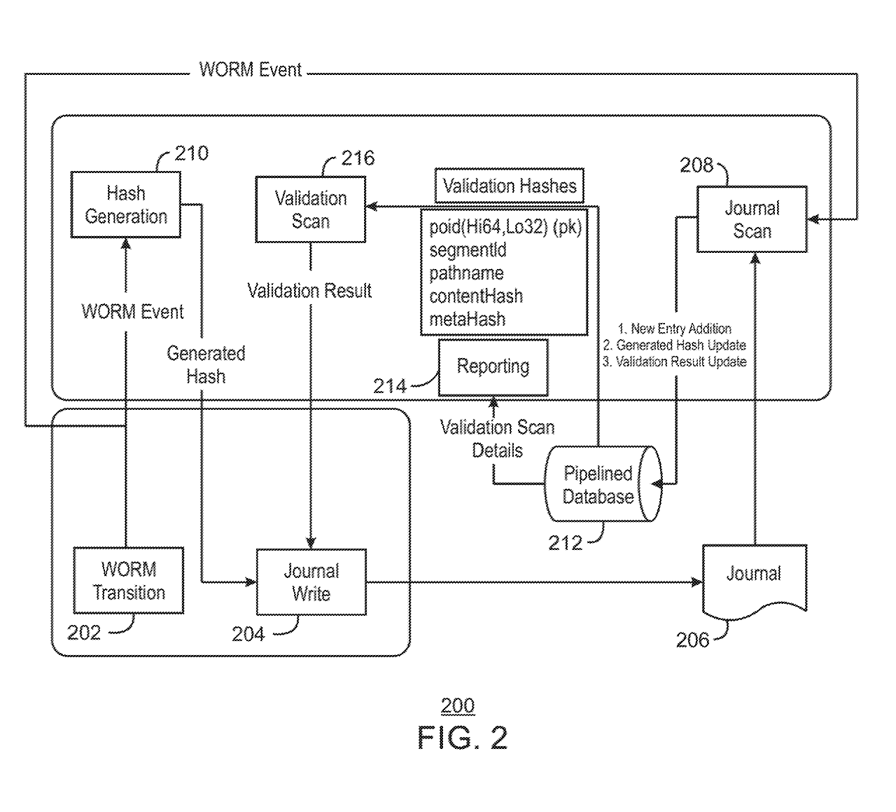

FIG. 2 is a block diagram illustrating retention and validation of a file in a file system, in accordance with examples of the present disclosure. The examples discussed herein can be performed by a computer containing a processor and a storage device. In one example, a file contained in the file system of the storage device is retained by undergoing a write-once-read-many (WORM) transition 202. WORM describes a form of storage in which information, once written, cannot be further modified.

At block 204, following the WORM transition 202, the WORM event can be written into a journal 206. The journal 206 may be a collection of files that can be made available for all user mode processes involving the file system. The journal 206 can also provide a record of updates made to each file in the file system. At block 208, the WORM event is scanned and picked up. Identification and location information regarding the retained file, such as file's unique ID, Segment ID, and the path name can be determined. At block 210, a hash of the content and metadata of the file can be generated. The file identification and location information, along with the generated hash, can be stored in an entry of a pipelined database 212, such that the hash is associated with the file identification and location information. At block 214, information stored in the pipelined database 212 can be made available for easy query and retrieval by the computer's reporting systems as well as future scans.

A validation scan 216 may be performed by either user initiation or by a schedule in the computer. The processor of the computer can run a query on the pipelined database 212 to see which files are under retention. The validation scan 216 can generate a new hash from a retained file under scan. The new hash is compared to the hash associated with the retained file in the pipelined database 212. The results of the validation scan 216 can be updated to the journal 206 and the pipelined database 212.

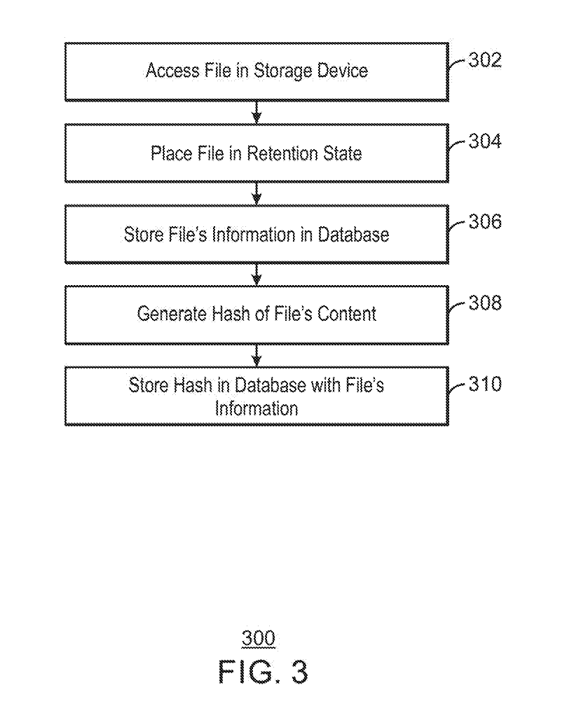

FIG. 3 is a process flow diagram of a method for retaining a file, in accordance with examples of the present disclosure. The method 300 can be performed by a computing system 100 (as seen in FIG. 1) containing a processor 102 and a storage device 116.

At block 302, the processor accesses a file in the storage device. The file may be part of a file system. At block 304, the processor places the file in a retention state. Retention can allow the file to be stored for a set period of time. In some examples, the file undergoes write-once-ready-many (WORM) transition. In some examples, the retention event is recorded into a journal.

At block 306, the processor stores the file's information in a database. The file's information can include a file ID, a segment ID, and a path name. The file ID is a unique identifier for the file. The segment ID indicates what segment of the file system the retained file exists on. In some examples, the file's information can be entered in a query-able table of a pipelined database.

At block 308, the processor generates a hash of the file's content. The hash may be a small, arbitrary datum mapped to the retained file. The hash may be a checksum that represents the content of the retained file. In some examples, a hash of the file's metadata can also be generated.

At block 310, the processor stores the hash into the database with the file's information. The hash can be stored in the same table as the file's information, such that the hash is associated with the file's information. When queried, the database can provide the hash along with the information pertaining to the file. In some examples, the stored hash can be used for several other applications beyond validation scans.

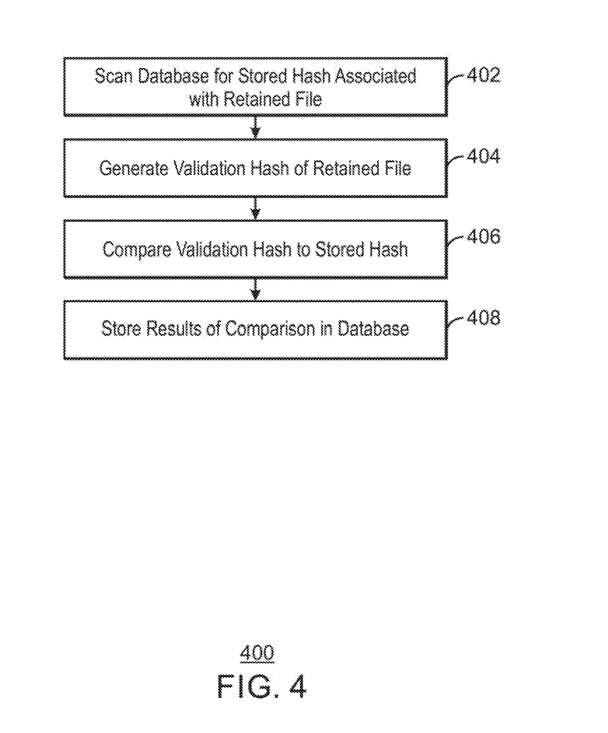

FIG. 4 is a process flow diagram of a method for performing a validation scan, in accordance with examples of the present disclosure. The method 400 can be performed by a computing system 100 (as seen in FIG. 1) containing a processor 102 and a storage device 116. The validation scan may be performed on a file that has been retained with the method described in FIG. 3.

At block 402, the processor scans a database for a stored hash associated with a retained file. The processor can run a query on the database to see which files in a file system are associated with a hash. The processor can retrieve a file path corresponding to a retained file with a stored hash.

At block 404, the processor generates a validation hash of the retained file. At block 406, the processor compares the validation hash to the stored hash. For a plurality of retained files, a plurality of validation hashes and subsequent comparisons to stored hashes may be performed simultaneously. In other words, multiple validation scans can be performed in parallel.

At block 408, the processor stores results of the comparison in the database. The results can be entered into the same table as the stored hash and information pertaining to the retained file. The information stored in the table can be made available to the computing system's reporting tools. In some examples, the journal is also updated with the results from the comparison. Thus, the journal can provide a history log of the file's retention history.

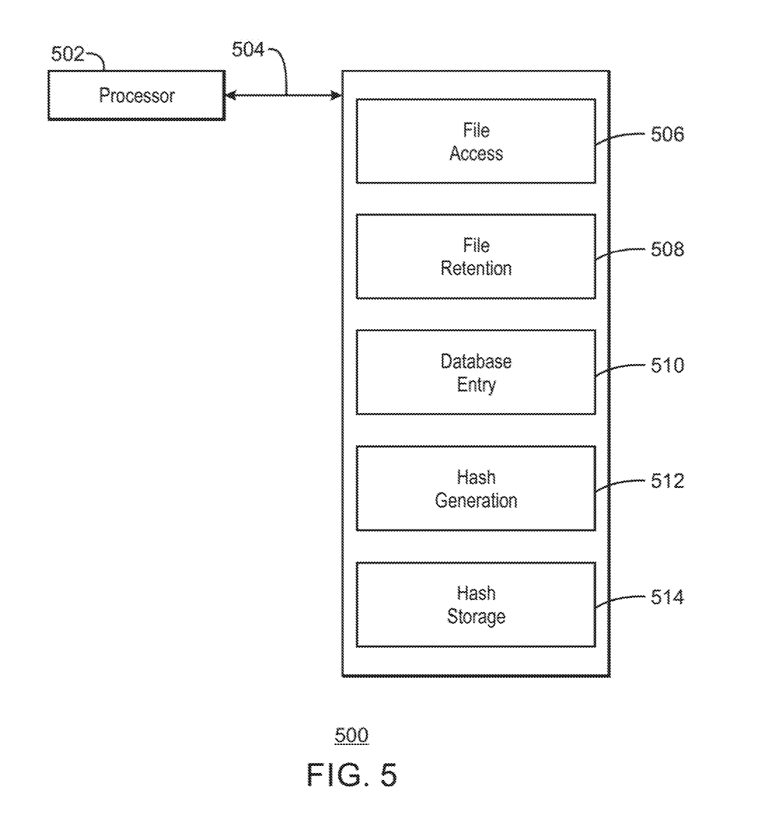

FIG. 5 is a block diagram of a tangible, non-transitory computer-readable medium containing instructions configured to direct a processor to retain a file, in accordance with examples of the present disclosure. The tangible, non-transitory computer-readable medium 500 can include RAM, a hard disk drive, an array of hard disk drives, an optical drive, an array of optical drives, a non-volatile memory, a universal serial bus (USB) drive, a digital versatile disk (DVD), or a compact disk (CD), among others. The tangible, non-transitory computer-readable media 500 may be accessed by a processor 502 over a computer bus 504. Furthermore, the tangible, non-transitory computer-readable medium 500 may include instructions configured to direct the processor 502 to perform the techniques described herein.

As shown in FIG. 5, the various components discussed herein can be stored on the non-transitory, computer-readable medium 500. A file access module 506 is configured to access a file in a storage device. A file retention module 508 is configured to place the file in a retention state. A database entry module 510 is configured to store the file's information in a database. A hash generation module 512 is configured to generate a hash of the file's content. A hash storage module 514 is configured to store the hash in the database with the file's information.

The block diagram of FIG. 5 is not intended to indicate that the tangible, non-transitory computer-readable medium 500 are to include all of the components shown in FIG. 5. Further, the tangible, non-transitory computer-readable medium 500 may include any number of additional components not shown in FIG. 5, depending on the details of the specific implementation.

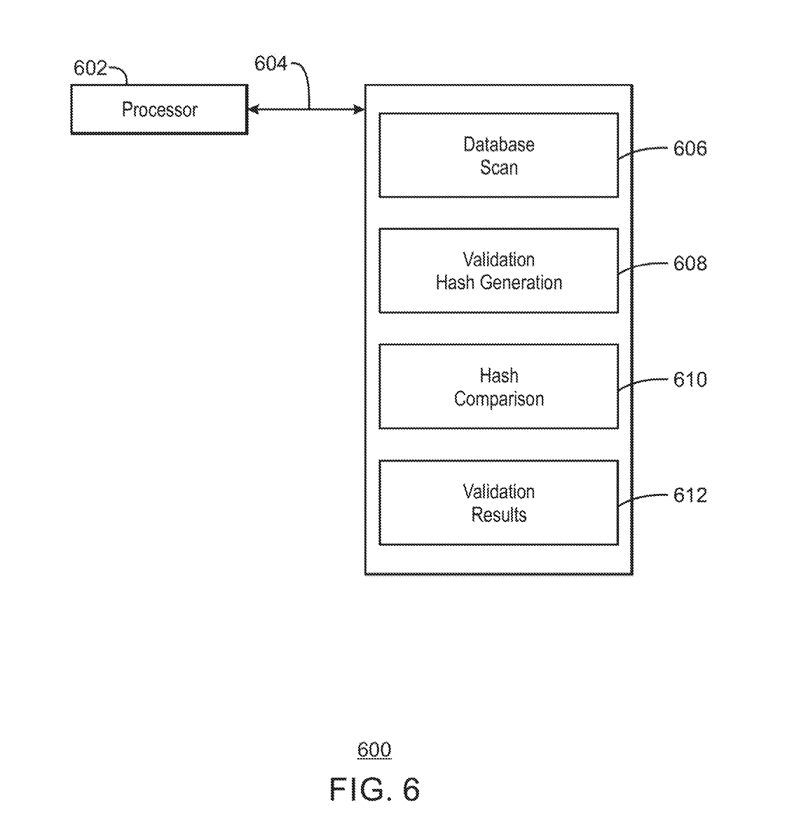

FIG. 6 is a block diagram of a tangible, non-transitory computer-readable medium containing instructions configured to direct a processor to perform a validation scan, in accordance with examples of the present disclosure. The tangible, non-transitory computer-readable medium 600 can include RAM, a hard disk drive, an array of hard disk drives, an optical drive, an array of optical drives, a non-volatile memory, a universal serial bus (USB) drive, a digital versatile disk (DVD), or a compact disk (CD), among others. The tangible, non-transitory computer-readable media 600 may be accessed by a processor 602 over a computer bus 604. Furthermore, the tangible, non-transitory computer-readable medium 600 may include instructions configured to direct the processor 602 to perform the techniques described herein.

As shown in FIG. 6, the various components discussed herein can be stored on the non-transitory, computer-readable medium 800. A database scan module 606 is configured to scan a database for a stored hash associated with a retained file. A validation hash generation module 608 is configured to generate a validation hash of the retained file. A hash comparison module 610 is configured to compare the validation hash to the stored hash. A validation results module 612 is configured to store results of the comparison in the database.

The block diagram of FIG. 6 is not intended to indicate that the tangible, non-transitory computer-readable medium 600 are to include all of the components shown in FIG. 6. Further, the tangible, non-transitory computer-readable medium 600 may include any number of additional components not shown in FIG. 6, depending on the details of the specific implementation.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claim:

1. A method, comprising:
accessing a file in a storage device;
placing the file in a retention state;
storing the file's information in a database;
generating a hash of the file's content; and
storing the hash in the database with the file's information.

2. The method of claim 1, comprising recording the retention of the file into a journal.

3. The method of claim 1, comprising:
scanning the database for the stored hash associated with the retained file;
generating a validation hash associated with the retained file;
comparing the validation hash to the stored hash; and
storing results of the comparison in the database.

4. The method of claim comprising updating the journal with the results of the comparison.

5. The method of claim 1, wherein the data base is a pipelined database.

6. A system, comprising:
a retention module to provide instructions to retain a file such that the retained file can easily be accessed;
a processor to execute the instructions provided by the retention module wherein the instructions direct the processor to:
access a file in a storage device;
place the file in a retention state;
store the file's information in a database;
generate a hash of the file's content; and
store the hash in the database with the file's information.

7. The system of claim 6, wherein the instructions direct the processor to record the retention of the file into a journal.

8. The system of claim 6, comprising:
a validation module to provide instructions to perform a validation scan on the retained file;
the processor to execute instructions provided by the validation module, wherein the instructions direct the processor to
scan the database for the stored hash associated with the retained file;
generate a validation hash associated with the retained file;
compare the validation hash to the stored hash; and
store results of the comparison in the database.

9. The system of claim 8, wherein the instructions direct the processor to update the journal with the results of the comparison.

10. The system of claim 6, wherein the database a pipelined database.

11. A tangible, non-transitory, computer-readable medium, comprising instructions configured to direct a processor to:
access a file in a storage device;
place the file in a retention state;
store the file's information in a database;
generate a hash of the file's content; and
store the hash in the database with the file's location.

12. The tangible, non-transitory,computer-readable medium of claim 11, comprising instructions configured to direct a processor to record t he retention of the file into a journal.

13. The tangible, non-transitory, computer-readable medium of claim 11, comprising instructions to direct the processor to:
scan the database for the stored hash associated with the retained file;
generate a validation hash associated with the retained file;
compare the validation hash to the stored hash; and
store results of the comparison in the database.

14. The tangible, non-transitory, computer-readable medium of claim 13, comprising instructions direct the processor to update the journal with the results of the comparison.

15. The tangible, non-transitory, computer-readable medium of claim 11, wherein the database is a pipelined database.
